(19) United States
(12) Patent Application Publication
(10) Pub. No.: US 2008/0040742 A1
(43) Pub. Date: Feb. 14, 2008

(54) Method and system for inserting advertisement data into an internet protocol television network

(75) Inventors: Jerald Robert Howcroft, Beverly Hills, MI (US); Thomas Hinman Adams, San Antonio, TX (US); Edward A. Walter, Boerne, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/503,517

(22) Filed: Aug. 11, 2006

(51) Int. Cl. H04N 5/445; H04N 7/10; H04N 7/025; G06F 3/00; G06F 13/00

(52) U.S. Cl. 725/34; 725/35; 725/46; 725/32

(57) ABSTRACT

A system and method are disclosed for distributing advertisement in an internet protocol television (IPTV) system. The method includes accepting at an IPTV server, targeted advertisement data from an advertisement client targeting a segment selected from an IPTV subscriber population based on IPTV subscriber profile data; inserting the targeted advertisement data into video data; sending the video data from the IPTV server to client devices associated with members of the selected segment of the IPTV subscriber population; and reporting to the advertisement client a quantity of members of the targeted segment that received the targeted advertisement data. The system includes an IPTV system processor for performing the method.

### FIELD OF THE DISCLOSURE

The present disclosure relates generally to delivering targeted advertisements.

### BACKGROUND

Advertisers can potentially save advertisement dollars by targeting their advertisements rather than indiscriminately broadcasting their advertisements to a general population of recipients. Advertisement distributors and providers that enable a targeting advertisement model can correspondingly increase their revenue per advertisement impression by providing targeted advertisement options for advertisers.

Targeted advertisements have historically been sent to large targeted geographic areas such as a particular city, so that regional advertisers reach only those advertisement recipients who are deemed by the advertiser as most likely to be responsive to their advertisements.

### BRIEF DESCRIPTION OF THE DRAWINGS

FIG. 1 is a schematic diagram of an illustrative embodiment of a high level example of an internet protocol television (IPTV) Service Provider Network Architecture;

FIG. 2 is a schematic diagram of an illustrative embodiment of a schematic illustration of a billing and advertisement service activation architecture in the IPTV system;

FIG. 3 is a schematic diagram of an illustrative embodiment of a breakdown of the functions performed in relation to the architecture depicted in FIG. 2;

FIG. 4 is a flow chart showing functions performed in an illustrative embodiment;

FIG. 5 is a schematic diagram of an illustrative embodiment showing a home zone and a travel zone in an IPTV network;

FIG. 6 is an illustration of a data structure provided in an illustrative embodiment; and

FIG. 7 is an illustrative embodiment of a machine for performing functions disclosed.

### DETAILED DESCRIPTION

In a particular embodiment a method for distributing advertisement in an internet protocol television (IPTV) system is disclosed. The method includes accepting at an IPTV server, targeted advertisement data from an advertisement client targeting a segment selected from an IPTV subscriber population based on IPTV subscriber profile data; inserting the targeted advertisement data into video data; sending the video data from the IPTV server to client devices associated with members of the selected segment of the IPTV subscriber population; and reporting to the advertisement client a quantity of members of the targeted segment that received the targeted advertisement data. In another aspect of a particular embodiment the subscriber profile data are selected from the group consisting of behavioral data and demographic data. In another aspect of a particular embodiment reporting further comprises reporting to the advertisement client how many members of the targeted segment watched the entire targeted advertisement data in full without switching IPTV channels. In another aspect of a particular embodiment reporting further includes reporting to the advertisement client a quantity of members of the targeted segment that received the targeted advertisement data and a time during the targeted advertisement data delivery at which an IPTV channel switch occurred. In another aspect of a particular embodiment reporting further includes reporting to the advertisement client how many members of the targeted segment received the targeted advertisement data in a home zone and how many members of the IPTV targeted segment received the targeted advertisement data in a travel zone.

In another aspect of a particular embodiment the method further includes billing the advertisement client based on a quantity selected from the group consisting of a quantity indicating how many members of the targeted segment received the targeted advertisement data, a quantity indicating how many members of the targeted segment received the targeted advertisement data in a home zone, a quantity indicating how many members of the targeted segment received the targeted advertisement data in a travel zone, a quantity indicating how many members of the targeted segment watched the entire targeted advertisement data in the home zone and a quantity indicating how many members of the targeted segment watched the entire targeted advertisement in the travel zone. In another aspect of a particular embodiment the profile data includes programs being watched, the length of time watched and time of day watched, advertisement received, advertisement watched, data recorded to a Digital Video Recorder (DVR), times of the occurrence of switching channels, data collected related to website viewing behaviors, emails, electronic purchases over the internet, text messaging and telephone calls. In another aspect of a particular embodiment the advertising data is provided from an advertising server located at a super head end and the advertising data is inserted into the video data at a regional head end. In another aspect of a particular embodiment the billing quantity is calculated at a regional head end and sent to a traffic billing server at a super head end for billing.

In another particular embodiment a system for distributing advertisement in an internet protocol television (IPTV) system is disclosed. The system includes a processor in communication with memory and a computer program stored in the memory containing instructions for execution by the processor. The computer program further includes instructions to accept at an IPTV server, targeted advertisement data from an advertisement client targeting a segment selected from an IPTV subscriber population based on IPTV subscriber profile data, instructions to insert the targeted advertisement data into video data, instructions to send the video data from the IPTV server to client devices associated with members of the selected segment of the IPTV subscriber population and instructions to report to the advertisement client a quantity of members of the targeted segment that received the targeted advertisement data. In another aspect of a particular embodiment the subscriber profile data are selected from the group consisting of behavioral data and demographic data. In another aspect of a particular embodiment in the computer program, the instructions to report further includes instructions to report to the advertisement client a quantity of members of the targeted segment watched the entire targeted advertisement data in full without switching IPTV channels from the targeted advertisement data. In another aspect of a particular embodiment in the computer program, the instructions to report further includes instructions to report to the advertisement client a quantity of members of the targeted segment that received the targeted advertisement data and a time during the targeted advertisement data delivery at which an IPTV channel switch occurred. In another aspect of a particular embodiment in the computer program, the instructions to report further includes instructions to report to the advertisement client how many members of the targeted segment received the targeted advertisement data in a home zone and how many members of the IPTV targeted segment received the targeted advertisement data in a travel zone. In another aspect of a particular embodiment the computer program further includes instructions to bill the advertisement client based on a quantity selected from the group consisting of a quantity indicating how many members of the targeted segment received the targeted advertisement data, a quantity indicating how many members of the targeted segment received the targeted advertisement data in a home zone, a quantity indicating how many members of the targeted segment received the targeted advertisement data in a travel zone, a quantity indicating how many members of the targeted segment watched the entire targeted advertisement data in the home zone and a quantity indicating how many members of the targeted segment watched the entire targeted advertisement in the travel zone. In another aspect of a particular embodiment the profile data includes data indicating programs being watched, the length of time watched and time of day watched, advertisement received, advertisement watched, data recorded to a Digital Video Recorder (DVR), times of the occurrence of switching channels, data collected related to website viewing behaviors, emails, electronic purchases over the internet, text messaging and telephone calls. In another aspect of a particular embodiment the advertising data is provided from an advertising server located at a super head end and the advertising data is inserted into the video data at a regional head end. In another aspect of a particular embodiment the billing quantity is calculated at a regional head end and sent to a traffic billing server at the super head end for billing.

In another particular embodiment a computer readable medium having stored thereon a computer program for distributing advertisement in an internet protocol television (IPTV) system is disclosed. The computer program further includes instructions to accept at an IPTV server, targeted advertisement data from an advertisement client targeting a segment selected from an IPTV subscriber population based on IPTV subscriber profile data, instructions to insert the targeted advertisement data into video data, instructions to send the video data from the IPTV server to client devices associated with members of the selected segment of the IPTV subscriber population and instructions to report to the advertisement client a quantity of members of the targeted segment that received the targeted advertisement data. In another aspect of a particular embodiment the subscriber profile data are selected from the group consisting of behavioral data and demographic data. In another aspect of a particular embodiment in the computer program, the instructions to report further includes instructions to report to the advertisement client a quantity of members of the targeted segment that watched the entire targeted advertisement data in full without switching IPTV channels from the targeted advertisement data. In another aspect of a particular embodiment in the computer program, the instructions to report further includes instructions to report to the advertisement client a quantity of members of the targeted segment that received the targeted advertisement data and a time during the targeted advertisement data delivery at which an IPTV channel switch occurred. In another aspect of a particular embodiment in the computer program, the instructions to report further includes instructions to report to the advertisement client how many members of the targeted segment received the targeted advertisement data in a home zone and how many members of the IPTV targeted segment received the targeted advertisement data in a travel zone. In another aspect of a particular embodiment the computer program further includes instructions to bill the advertisement client based on a quantity selected from the group consisting of a quantity indicating how many members of the targeted segment received the targeted advertisement data, a quantity indicating how many members of the targeted segment received the targeted advertisement data in a home zone, a quantity indicating how many members of the targeted segment received the targeted advertisement data in a travel zone, a quantity indicating how many members of the targeted segment watched the entire targeted advertisement data in the home zone and a quantity indicating how many members of the targeted segment watched the entire targeted advertisement in the travel zone. In another aspect of a particular embodiment the profile data includes data indicating programs being watched, the length of time watched and time of day watched, advertisement received, advertisement watched, data recorded to a Digital Video Recorder (DVR), times of the occurrence of switching channels, data collected related to website viewing behaviors, emails, electronic purchases over the internet, text messaging and telephone calls.

In another particular embodiment a data structure in memory is disclosed. The data structure includes a client ID field for containing data indicating a client device identifier; a home zone field for containing data indicating an advertisement server for a home zone associated with the client device; a travel zone field for containing data indicating a travel zone associated with the client device; and an advertisement received field for storing data indicating which advertisements the client device received in full without switching from the advertisement for creating statistics to send to a home server associated with the home zone.

An illustrative embodiment collects viewer behavioral information that can be analyzed to look at a whole family profile of IPTV subscribers or individual IPTV subscriber profiles. The subscriber profiles (“profiles”) also include but are not limited to profile data collected from subscribers during the subscription registration process. The data collected could be anything related to the IPTV video data incorporating programs being watched, the length of time watched and time of day watched, advertisement received, advertisement watched and data recorded to a Digital Video Recorder (DVR). The profiles also include times of the occurrence of switching channels so that the IPTV SP can determine if a targeted advertisement was watched, that is received without switching to another channel and if the channel is switched occurred during delivery of the targeted advertisement, the time at which the switching occurred. The switching time enables an advertisement client to determine exactly when the subscriber at a client device switched from the channel containing the targeted advertisement. The time of switching helps an advertisement client to determine when during the targeted advertisement they “lost” the viewer due to the viewer changing channels. The profile also includes behavioral data for IPTV subscribers. Behavioral data includes but is not limited to data collected related to website viewing behaviors, emails, electronic purchases over the internet, text messaging and telephone calls over the IPTV network or a related telephone data system.

For example, if a subscriber is researching buying a new television, over the internet, this information is collected and saved in the subscriber's profile. Subscriber profiles including associated STB or client device identifiers associated with the subscriber are stored in a database in the IPTV system. The IPTV network records these data in the subscriber profile of behavioral statistics for a population of IPTV subscribers. The SP presents the statistics for the IPTV population of subscribers to prospective advertisement clients who may select particular segments of the IPTV population of subscribers based on subscriber demographics and/or behavioral characteristics. The advertisement client may then target specific advertisement to segments of the IPTV subscriber population via video to client devices such as set top boxes (STBs) associated with a particular segment of the IPTV subscribers, having specific user profile characteristics including selected behavioral statistics and demographic data.

A particular illustrative embodiment enables real-time targeted advertisement based upon user identified preferences derived from the IPTV subscriber profiles containing statistics on behavior and demographic data. A user may enter profile data indicating likes and dislikes as far as interests in video programming ordered, selected and received and merchandise and services purchased. Similar targeting enables an illustrative embodiment to provided targeted screen pop-ups, video, etc. to a web viewing audience at a client device connected to the IPTV network.

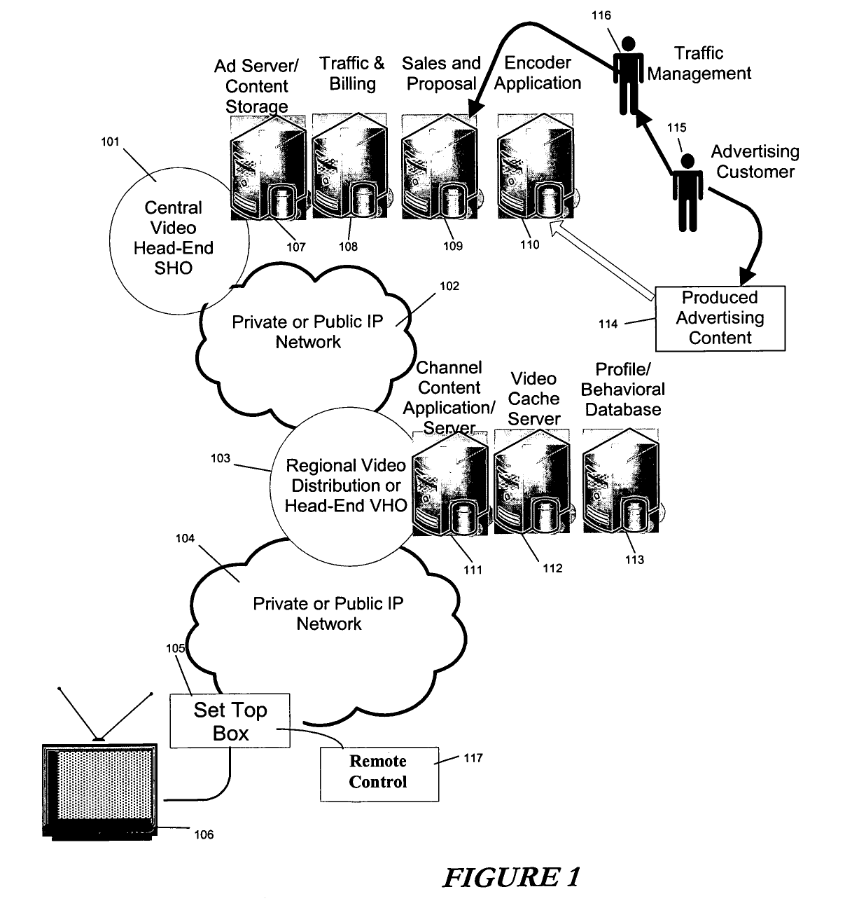

Turning now to FIG. 1, FIG. 1 depicts an illustrative embodiment of an IPTV architecture to support targeted advertisement. As shown in FIG. 1 the central video head end or SHO 101 includes but is not limited to the ad server/content storage device 107, the traffic and billing system 108, sales proposal system 109, and the encoder application 110. The produced advertisement content 114 which is produced by the advertisement customer 115 is provided to the encoder application at the SHO. The SHO encodes the targeted advertisement content 114 and distributes the advertisement content to IPTV subscribers via the public or private IP network 102. At the regional video distribution or head end VHO 103 the data from the central video head end SHO is distributed to individual IPTV subscribers over the public or private IP network 104. The VHO includes but is not limited to the channel content application/server 111, the video cache server 112, and the profile/behavioral database 113. The profile behavioral database 113 can be stored at the VHO or at the SHO. In an illustrative embodiment, as a user views the IPTV television 106 monitor displaying IPTV data received on a STB 105, the IPTV system monitors the channel viewing and channel changing occurrence data as input to the STB by a subscriber via remote control (RC) 117 is collected in the subscriber profile in the IPTV profile/Behavioral Database 113. From an Advertisement client 115 perspective the advertisement client works with the IPTV Traffic Management office 116 to purchase behavioral and demographic data based advertisement spot inventory. The Advertisement Traffic Sales and Management 116 uses the Sales and Proposal system 109 to generate service proposals, make behavioral advertisement sales, and enter the sale information into the Traffic and Billing system 108. Thus an advertisement client may purchase an advertisement spot to target, an IPTV population segment having a particular demographic, a particular behavior and/or a particular demographic exhibiting a particular behavior.

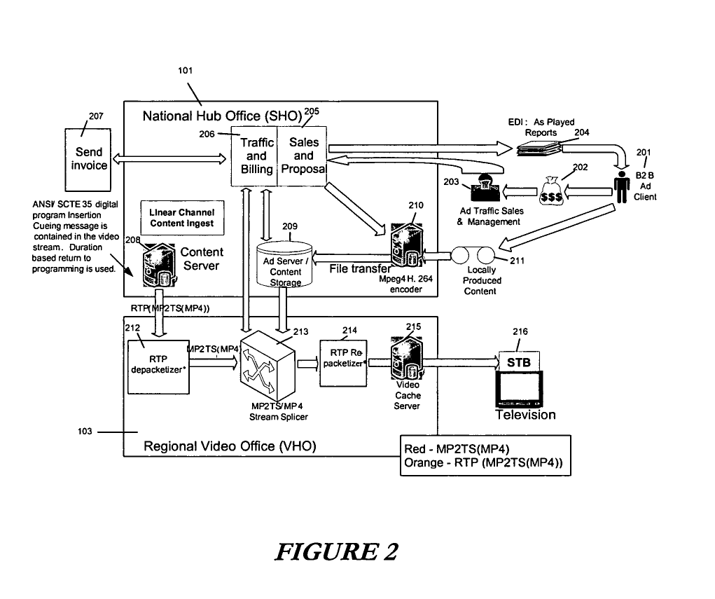

Turning now to FIG. 2, FIG. 2 depicts an illustrative embodiment of an IPTV Local Advertisement insertion model. The advertisement client 201 contacts SP Sales agent to purchase local advertisement spot inventory. The advertisement client pays 202 the IPTV SP to run local advertisements as agreed upon by both parties. The advertisement traffic sales and management module 203 in the IPTV system uses the traffic and billing system to generate service proposals, make local advertisement sales, and enter the sales information into the traffic and billing system. From this the Electronic Data Inter-exchange interface from the Traffic and Billing system to the Advertisement client to send “As Run/Played” reports 204 showing when the client's advertisements were actually run. The “Sales and Proposal” system 205 is used by the Advertisement Traffic Sales and Management personal to generate local advertisement proposals and sell spot inventory to the Advertisement Client. The “Traffic and Billing” system 206 takes the information regarding what was sold in order to schedule the local advertisement insertions into the live TV programming schedule. The “Traffic and Billing” system sends the invoice to the advertisement client 201 for the service provided. The invoice 207 is mailed to the advertisement client 201. There may also be other external systems involved with the invoicing if the service provider wants to integrate this billing information with other billing information they are sending to the same client (integrated billing).

In an illustrative embodiment, the local or home advertisement 211 is encoded in Moving Pictures Experts Group 4 (MPEG 4) or H.264 format 210. The local advertisement data can be received from the advertisement client 201 in tape or electronic form. Live or Programmed TV content is ingested into the Content Server 208 and includes the cue tone information used to tell the Advertisement server 209/Splice Equipment 213 when to insert the advertisement. The “Traffic and Billing” system 206 sends the Advertisement Insertion schedule to the Advertisement Server(s) 209. The “Traffic and Billing” system 206 received information from the Advertisement servers 206 regarding the actual completion of the Advertisement Insertions. The RTP header is removed from the linear programming (live TV) content packet via the “RTP De-Packetizer” 212. The MPEG4/H.264 live TV content is sent on its way to the consumers TV/Set Top Box for viewing with the original commercial still in tact. The local Advertisement Insertion Stream Splicer 213 splices in the home advertisement over the original advertisement when the cue tone indicates. After splicing the RTP header is added back onto the packet via a “Re-Packetization” process 214. The Video Cache server 215 caches the linear video content for distribution to the customer's home for viewing on their TV via their Set Top Box 216.

An illustrative embodiment provides flexibility to see the demographics of particular behavior in the IPTV system subscriber population as well as the behavior of a particular demographic in the IPTV subscriber population. The National Hub Office 101 (SHO) can be a single office location that consists of satellite acquisition, receive capabilities, base-band signal processing/switching/redundancy, encoding, and video on demand (VoD) acquisition/ingest facilities. This location provides all linear stream multicast signals and unicast VoD for the entire IPTV network. The Regional Hub Offices 103 are multiple office locations consist of off-air antenna and receive equipment, base-band signal processing/switching/redundancy, encoding, and VoD customer facing servers. The regional hub offices provide all off-air local multicast signals (joined with linear regional hub office signals).

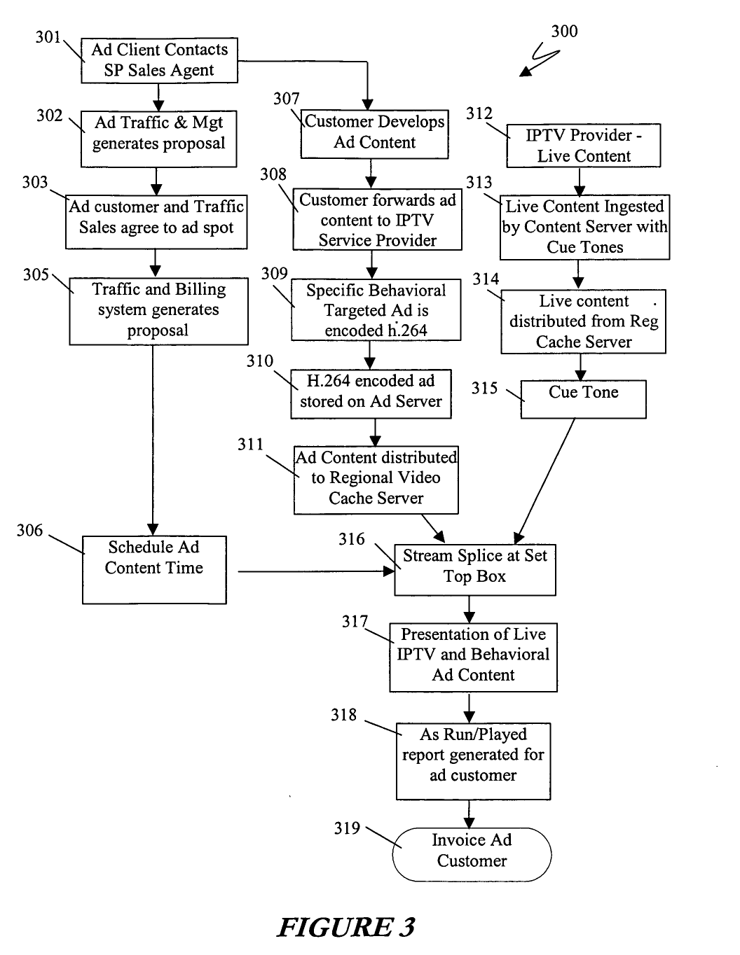

Turning now to FIG. 3 in an illustrative embodiment at block 301 an advertisement client contacts a service provider sales agent. At block 302 the advertisement traffic and management department for the IPTV service provider generate a proposal for an advertisement spot. At block 303 the advertisement client selects a segment of the IPTV subscriber population based on behavioral characteristics and/or demographic characteristics to be targeted by the advertisement spot.

The advertisement customer and the traffic sales department of the IPTV service provider agree to an advertisement spot targeting the selected segment of the IPTV subscriber population. The advertisement client may target a particular segment of the IPTV subscriber population based on behavioral data such as program watching, purchasing of certain types of goods or services and time of day watching or based on demographics such as languages spoken, age, gender and geographic location. At block 305 the traffic and billing department at the IPTV service provider generates a proposal and forwards it to the IPTV schedule advertisement and content time system. At this point the advertisement spot has been selected to target a particular demographic or behavioral characteristic of the IPTV subscriber population and schedules to be inserted and delivered to client identifiers associated with the targeted segment at a particular time. The advertisement client customer develops the advertisement content at block 307. The advertisement content is developed in accordance with the targeted segment of the IPTV subscriber population so that the advertisement content is appealing to the targeted segment. At block 308 the advertisement customer forwards the advertisement content to the IPTV service provider. At block 309 the specific behavioral targeted advertisement is encoded in H.264 format and at block 310 the H.264 encoded advertisement is stored on an advertisement server in the IPTV system. At block 311 the advertisement content is distributed to a regional VHO cache server and is now ready to be spliced into video delivered to the set top box at block 316.

At block 312 the IPTV service provider provides live content or stored programming. At block 313 video content data are adjusted by content server and cue tones inserted for the insertion of the advertisements data down stream. At block 314 the video content data is distributed from a regional cache server and a cue tone generated at block 315. At block 316 the targeted advertisement data is spliced into video data delivered to the set top box. The targeted advertisement data can also be delivered to the set top box and inserted into video data delivered to the set top box at the set top box or the targeted advertisement data can be spliced into the video prior to delivery to the set top box. At block 317 the video with the advertisement inserted are viewed at the display associated with the set top box or other client device.

At block 318 the IPTV system monitors the deliver of the targeted advertisement data and the switching activity during deliver of the advertisement and generates an as run/played report for the advertisement customer. The advertisement “as run/played” report can include the success of the advertisement, that is the number of subscribers in the IPTV population that received the targeted advertisement, the number of subscribers in the targeted IPTV population segment that received the targeted advertisement, the number of subscribers in each of the population and the segment selected from the total population that received the targeted advertisement and did not switch channels during delivery of the targeted advertisement, and the time at which subscribers did switch from the targeted advertisement data when the targeted advertisement data was received by the subscribers.

At block 319 an invoice is generated billing the advertisement customer based on the success of the advertisement as shown in the as run/played report. The invoice to the advertisement client can be based on the success of the advertisement, that is, how many subscribers received the targeted advertisement data, how many subscribers received the target advertisement data in a selected segment of the IPTV subscriber population which was targeted to receive the advertisement data, and how many targeted subscribers received the advertisement data in full without changing the channel.

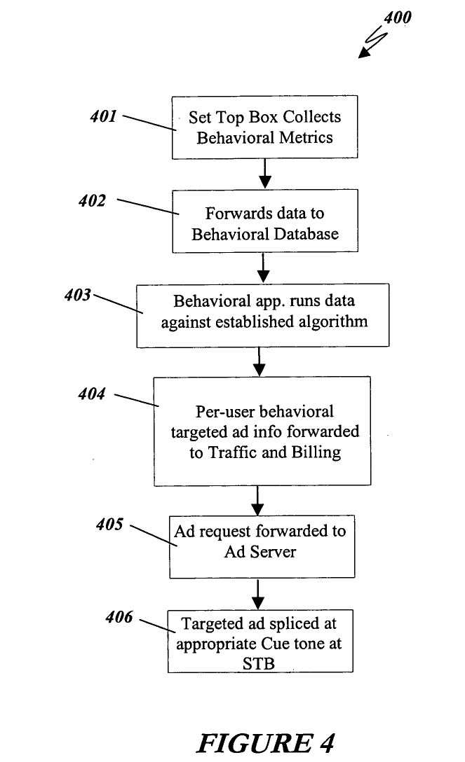

Turning now to FIG. 4, FIG. 4 illustrates the process flow for collection of subscriber behavior for use in determination of type of advertisement to be displayed to the subscriber. The STB or another client device associated with a subscriber collects the user viewing and behavioral data at 401. The client device/STB also collects any web or other types of use activity through the STB. This data would be forwarded to the profile/Behavioral Database at 402. The raw behavioral and profile data is processed at 403 and metrics or a request for specific targeted advertisement content is sent to the Traffic and Billing application at 404. The targeted advertisement data is then sent to the Advertisement Server at 405. The targeted advertisement data is then spliced and sent to the STB or another client device associated with the subscriber.

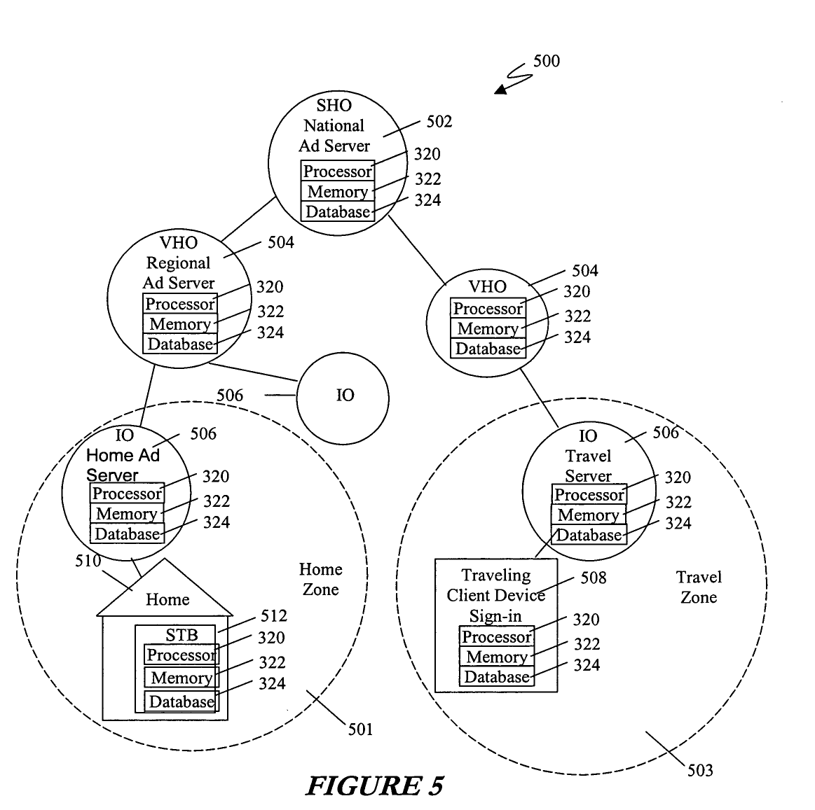

Turning now to FIG. 5 in an illustrative embodiment a home zone 501 associated with a home advertisement server 506 and a travel zone 503 associated with a traveling client device and travel server 506 are illustrated. In an illustrative embodiment a traveling client device 508 in a travel zone 503 issues a request to a travel server 506 to receive home advertisement from the home advertisement server 506 in the home zone 501. The home advertisement server can be associated with the home location for a particular client and may be located in either an intermediate office (IO) 506, a VHO regional server 504 or a national server SHO 502. Thus the advertisement server may be located in either, the SHO, VHO or IO and contain home advertisement content related to a registration address for set top box in an IPTV system. Home advertisement server 506 may be distributed logically and/or physically between the IO, VHO and SHO and may contain national, regional and local advertisements which are destined for residents in a home zone 501 or for traveling client devices in a travel zone. When a traveling client device sign-in 508 signs in to a travel server 506 the identity of the traveling client is tied back to an IPTV system subscriber database 324 in an IPTV server (SHO, VHO or IO) and identifies the traveling client by a log-on ID or MAC address for a client device utilized in signing on to the IPTV system. This identity for the traveling client is tied to an IPTV registration database 324 which can be kept in the SHO, VHO or IO. The registration database includes profiles for a subscriber such as the home address or registration address for the set top box in home 510. As shown in FIG. 5 each set top box, IO, VHO and SHO and traveling client include a processor 320, memory 322, and database 324.

When a request is received from a traveling client at a travel server the IPTV system searches for a home advertisement server containing advertisements associated with the traveling client device's registered home address. These home advertisements are collected and served from the home advertisement server to the traveling server in unicast. If more than a predetermined threshold number of traveling client devices has requested the same home advertisement server content through the same travel server then the home advertisement server content is multicast to a multiplicity of traveling client devices who requested home advertisement from a particular travel server 506. Likewise if a plurality of travel servers are served by a particular VHO and are requesting the same home advertisement content then the home advertisement content can be unicast from the home advertisement server located at the IO, VHO or SHO to the travel server(s) associated with the traveling client devices. The requesting home servers may then unicast or multicast the home advertisement content to the requesting traveling client devices. The home advertisement content is multicast from a travel server whenever a predetermined threshold number of traveling client devices, for example, two traveling client devices have requested the same home advertisement content in the same travel zone. The predetermined threshold can be selected based on network load conditions and available bandwidth or other conditions selected by the IPTV service provider.

In an illustrative embodiment a service provider collects behavioral data, statistics and advertisement watching statistics from the client devices. An advertisement client can view these statistics in or along with a subscriber profile to see the demographic data of the subscriber population and the associated viewing habit for the subscriber demographics. An advertisement client can purchase a selection target from the statistics to target a particular demographic population. The advertisement client then provides an advertisement it deems suitable for the targeted demographic population selected from the SP behavioral and demographics statistics. The service provider will then send the advertisement to the targeted demographic group as selected by the advertisement client. The advertisements might be targeted as exclusively only to the demographic population selected by the advertisement client or may include nonexclusive constraints in sending the advertisement to the subscribers.

The service provider reports which advertisements were watched and by whom as well as which advertisements were watched in full. Advertisements are deemed as “watched in full” when the advertisement is received at a client device without changing the channel or IP address during the advertisement. Advertisements that are not watched in full are those advertisements that resulted in changing of the channel during delivering the advertisement to the client device. Thus the SP can report the success of the advertisement (i.e., quantity of advertisements delivered to client devices, quantity of advertisements delivered to targeted client devices, advertisements watched in full, etc.) with the targeted group that is how many of the targeted demographic group actually received the advertisement and how many of the targeted demographic group actually watched the advertisement in full. The advertisement client may agree with the service provider to pay based on the success of the advertisement. In an illustrative embodiment the IPTV system keeps track of how many traveling subscribers receive targeted advertisements and how many traveling subscribers receive the targeted advertisement in full.

The success of the advertisement can be defined as the number of hits (quantity of targeted devices receiving the advertisement) in the targeted demographic in combination with the number of hits (quantity of targeted devices receiving the advertisement in full without switching IP addresses or channels) in the targeted demographic area which resulted in the commercial being watched fully, that is without being switched during the commercial. These success measurements and targeted advertisements apply to traveling client devices associated with IPTV system subscribers within a particular demographic. Thus the success of an advertisement can include those traveling client devices associated with IPTV subscribers in the database who are within the targeted demographic. A traveling client device associated with a targeted subscriber may receive targeted advertisement from their home zone while outside of the home zone in a travel zone and these statistics will be reported by the service provider and billed to the advertisement client based on the success of the advertisements provided to those subscribers in the demographic targeted by the ad client.

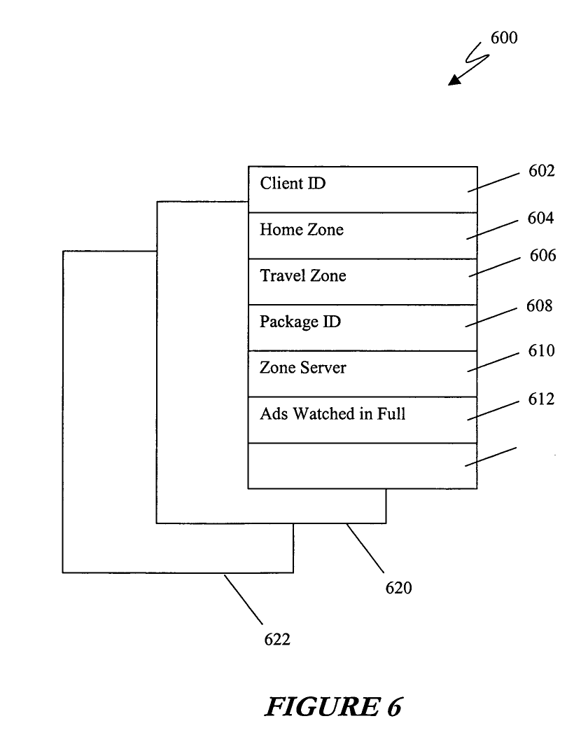

Turning now to FIG. 6 a data structure utilized in an illustrative embodiment is depicted. As shown in FIG. 6 the data structure 600 contains a client ID field 602, a home zone field 604, a travel zone field 606, package ID field 608, a zone server field 610 and advertisements watched in full field 612. Multiple data structures for multiple different client devices 620 and 622 may also be stored in memory for correlating between or matching client ID having the same home zone and the same travel zone for delivering content to the client devices identified by the client ID while traveling.

The client ID field contains data indicating a client device identity which is associated with a particular subscriber and a particular subscriber profile in the IPTV network data base. The home zone field contains data indicating an advertisement server for a home zone associated with the client device. The travel zone field contains data indicating a travel zone associated with the client device.

The package identifier field contains data for indicating an IPTV package for the client device for determining a quantity of advertisements to send to the client device. Different levels of advertisement can be sent. A credit toward the purchase of IPTV service is adjusted for advertisements watched by a user at a client device. The more advertisements a client device receives and watches in full, the more credit it receives toward pay for IPTV service. An advertisement is deemed watched in full when a client device receives the advertisement inserted into content without switching to another IP address during reception of the advertisement. The switching/not switching during advertisements is monitored by the client device or the travel server and stored in the data structure. The advertisements received field stores data indicating which advertisements the client device has received in full without switching from the targeted advertisement data for creating statistics to send to a home IPTV server associated with the home zone.

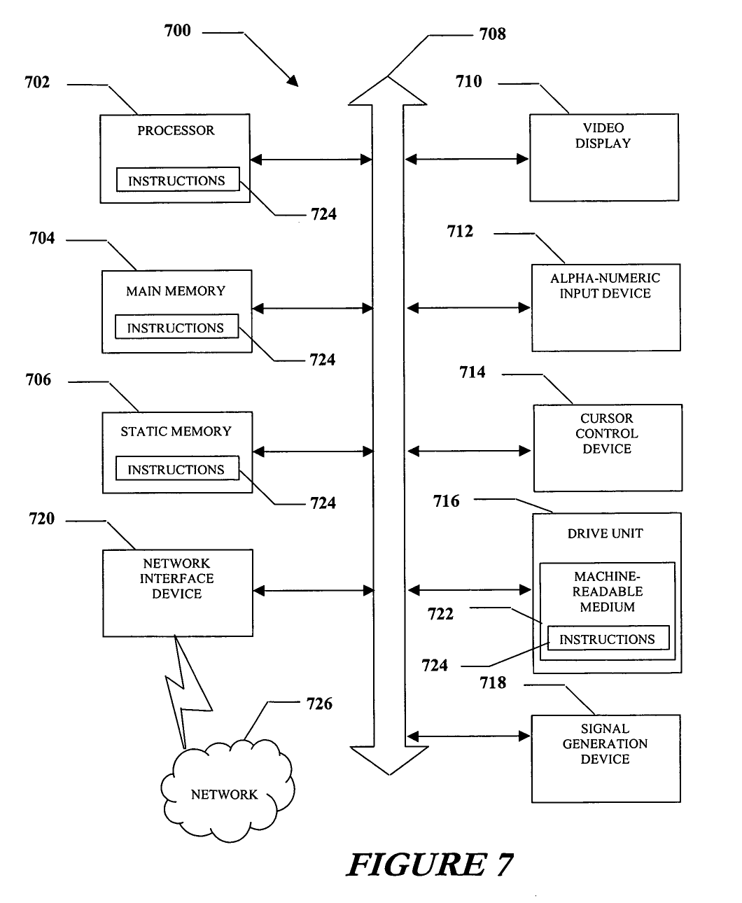

Turning now to FIG. 7, FIG. 7 is a diagrammatic representation of a machine in the form of a computer system 700 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated in herein above. The instructions 724 may also reside, completely or at least partially, within the main memory 704, the static memory 707, and/or within the processor 702 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “illustrative embodiment” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the illustrative embodiment has been described with reference to several illustrative embodiments, it is understood that the words that have been used are words of description and illustration, rather than words of limitation. Changes may be made within the purview of the appended claims, as presently stated and as amended, without departing from the scope and spirit of the illustrative embodiment in its aspects. Although the illustrative embodiment has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present illustrative embodiment, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

What is claimed is:

1. A method for distributing targeted advertisement data in an internet protocol television (IPTV) system, comprising:
accepting at an IPTV server, the targeted advertisement data from an advertisement client targeting a segment selected from an IPTV subscriber population based on IPTV subscriber profile data;
inserting the targeted advertisement data into video data;
sending the video data from the IPTV server to client devices associated with members of the selected segment of the IPTV subscriber population; and
reporting to the advertisement client a quantity of members of the targeted segment that received the targeted advertisement data.

2. The method of claim 1, wherein the subscriber profile data are selected from the group consisting of behavioral data and demographic data.

3. The method of claim 1, wherein reporting further comprises reporting to the advertisement client how many members of the targeted segment watched the targeted advertisement data without switching IPTV channels.

4. The method of claim 1, wherein reporting further comprises reporting to the advertisement client a quantity of members of the targeted segment that received the targeted advertisement data and a time during the targeted advertisement data delivery at which an IPTV channel switch occurred.

5. The method of claim 1, wherein reporting further comprises reporting to the advertisement client how many members of the targeted segment received the targeted advertisement data in a home zone and how many members of the IPTV targeted segment received the targeted advertisement data in a travel zone.

6. The method of claim 1, further comprising:
billing the advertisement client based on a quantity selected from the group consisting of a quantity indicating how many members of the targeted segment received the targeted advertisement data, a quantity indicating how many members of the targeted segment received the targeted advertisement data in a home zone, a quantity indicating how many members of the targeted segment received the targeted advertisement data in a travel zone, a quantity indicating how many members of the targeted segment watched the entire targeted advertisement data in the home zone and a quantity indicating how many members of the targeted segment watched the entire targeted advertisement in the travel zone.

7. The method of claim 1, wherein the profile data comprises programs being watched, the length of time watched and time of day watched, advertisement received, advertisement watched, data recorded to a Digital Video Recorder (DVR), times of the occurrence of switching channels, data collected related to website viewing behaviors, emails, electronic purchases over the internet, text messaging and telephone calls.

8. The method of claim 1, wherein the advertising data is provided from an advertising server located at a super head end and the advertising data is inserted into the video data at a regional head end.

9. The method of claim 6, wherein the billing quantity is calculated at a regional head end and sent to a traffic billing server at a super head end for billing.

10. A system for distributing advertisement in an internet protocol television (IPTV) system, comprising:
a processor in communication with memory; and
a computer program stored in the memory containing instructions for execution by the processor, the computer program further comprising instructions to accept at an IPTV server, targeted advertisement data from an advertisement client targeting a segment selected from an IPTV subscriber population based on IPTV subscriber profile data, instructions to insert the targeted advertisement data into video data, instructions to send the video data from the IPTV server to client devices associated with members of the selected segment of the IPTV subscriber population and instructions to report to the advertisement client a quantity of members of the targeted segment that received the targeted advertisement data.

11. The system of claim 10, wherein the subscriber profile data are selected from the group consisting of behavioral data and demographic data.

12. The system of claim 10, wherein in the computer program, the instructions to report further comprise instructions to report to the advertisement client a quantity of members of the targeted segment watched the entire targeted advertisement data in full without switching IPTV channels from the targeted advertisement data.

13. The system of claim 10, wherein in the computer program, the instructions to report further comprise instructions to report to the advertisement client a quantity of members of the targeted segment that received the targeted advertisement data and a time during the targeted advertisement data delivery at which an IPTV channel switch occurred.

14. The system of claim 10, wherein in the computer program, the instructions to report further comprise instructions to report to the advertisement client how many members of the targeted segment received the targeted advertisement data in a home zone and how many members of the IPTV targeted segment received the targeted advertisement data in a travel zone.

15. The system of claim 10, the computer program further comprises:
instructions to bill the advertisement client based on a quantity selected from the group consisting of a quantity indicating how many members of the targeted segment received the targeted advertisement data, a quantity indicating how many members of the targeted segment received the targeted advertisement data in a home zone, a quantity indicating how many members of the targeted segment received the targeted advertisement data in a travel zone, a quantity indicating how many members of the targeted segment watched the entire targeted advertisement data in the home zone and a quantity indicating how many members of the targeted segment watched the entire targeted advertisement in the travel zone.

16. The system of claim 10, wherein the profile data comprises data indicating programs being watched, the length of time watched and time of day watched, advertisement received, advertisement watched, data recorded to a Digital Video Recorder (DVR), times of the occurrence of switching channels, data collected related to website viewing behaviors, emails, electronic purchases over the internet, text messaging and telephone calls.

17. The system of claim 10, wherein an advertising server is located at a super head end for providing the advertising data and the advertising data is inserted into the video data at a regional head end.

18. The system of claim 15, wherein the billing quantity is calculated at a regional head end and sent to a traffic billing server at the super head end for billing.

19. A computer readable medium having stored thereon a computer program for distributing advertisement in an internet protocol television (IPTV) system, the computer program further comprising instructions to accept at an IPTV server, targeted advertisement data from an advertisement client targeting a segment selected from an IPTV subscriber population based on IPTV subscriber profile data, instructions to insert the targeted advertisement data into video data, instructions to send the video data from the IPTV server to client devices associated with members of the selected segment of the IPTV subscriber population and instructions to report to the advertisement client a quantity of members of the targeted segment that received the targeted advertisement data.

20. The medium of claim 19, wherein the subscriber profile data are selected from the group consisting of behavioral data and demographic data.

21. The medium of claim 19, wherein in the computer program, the instructions to report further comprise instructions to report to the advertisement client a quantity of members of the targeted segment that watched the entire targeted advertisement data in full without switching IPTV channels from the targeted advertisement data.

22. The medium of claim 19, wherein in the computer program, the instructions to report further comprise instructions to report to the advertisement client a quantity of members of the targeted segment that received the targeted advertisement data and a time during the targeted advertisement data delivery at which an IPTV channel switch occurred.

23. The medium of claim 19, wherein in the computer program, the instructions to report further comprise instructions to report to the advertisement client how many members of the targeted segment received the targeted advertisement data in a home zone and how many members of the IPTV targeted segment received the targeted advertisement data in a travel zone.

24. The medium of claim 19, wherein the computer program further comprises:
instructions to bill the advertisement client based on a quantity selected from the group consisting of a quantity indicating how many members of the targeted segment received the targeted advertisement data, a quantity indicating how many members of the targeted segment received the targeted advertisement data in a home zone, a quantity indicating how many members of the targeted segment received the targeted advertisement data in a travel zone, a quantity indicating how many members of the targeted segment watched the entire targeted advertisement data in the home zone and a quantity indicating how many members of the targeted segment watched the entire targeted advertisement in the travel zone.

25. The medium of claim 19, wherein the profile data comprises data indicating programs being watched, the length of time watched and time of day watched, advertisement received, advertisement watched, data recorded to a Digital Video Recorder (DVR), times of the occurrence of switching channels, data collected related to website viewing behaviors, emails, electronic purchases over the internet, text messaging and telephone calls.

26. A data structure in memory, comprising:
a client ID field for containing data indicating a client device identifier;
a home zone field for containing data indicating an advertisement server for a home zone associated with the client device;
a travel zone field for containing data indicating a travel zone associated with the client device; and
an advertisement received field for storing data indicating which advertisements the client device received in full without switching from the advertisement for creating statistics to send to a home server associated with the home zone.
